(19) United States
(12) Patent Application Publication
(10) Pub. No.: US 2008/0086563 A1
(43) Pub. Date: Apr. 10, 2008

(54) METHOD OF REMOTELY CONTROLLING LOCAL NETWORK DEVICES AND APPARATUS THEREFOR

(75) Inventors: Seong-kook SHIN, Seoul (KR); Akhil CHAPALAMADUGU, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/747,280

(22) Filed: May 11, 2007

(30) Foreign Application Priority Data
Oct. 9, 2006 (KR) 10-2006-0098157

(51) Int. Cl. G06F 15/173

(52) U.S. Cl. 709/225

(57) ABSTRACT

Provided is a method of remotely controlling local network devices. The method includes periodically receiving an access request from each local network device in a local network, to which direct access from the outside is blocked, if a connection between a local network device and a server located outside the local network is formed as a result of receiving the access request, determining whether a command to be transmitted to the local network device exists, and if it is determined that a command to be transmitted to the local network device exists, transmitting the command to the local network device while the connect is being formed to control the local network device.

### CROSS-REFERENCE TO RELATED PATENT APPLICATION

This application claims priority from Korean Patent Application No. 10-2006-0098157, filed on Oct. 9, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to remotely controlling local network devices, and more particularly, to a method of remotely controlling local network devices and an apparatus performing the method.

2. Description of the Related Art

Firewalls are hardware/software devices capable of establishing a policy against external undesirable hacking threats and can be divided into a gateway-level firewall and a personal firewall. In particular, the gateway-level firewall is installed at a gateway level and protects a local network from external networks.

Network Address Translation (NAT) is a process used to translate addresses in a communication network, and is used to translate a private Internet Protocol (IP) address to a public IP address in a network layer, which is the third layer of the Open Systems Interconnection (OSI) model, and is used to save Internet public IP addresses or used as a firewall to protect a users' private network connected to a public network, such as the Internet, from hackers.

When NAT is used as a firewall, NAT is used in a router, which is a device connected to an external communication network, i.e., the Internet. The router announces only public IP addresses assigned thereto to the outside, allows the inside of a local network to use only private IP addresses, and if necessary, translates between a public IP address and a corresponding private IP address in the local network. Thus, since a hacker must know private IP addresses in the local network in order to attack the local network, it is impossible for the hacker to attack the local network with only public IP addresses, and therefore, the local network can be protected.

FIG. 1 illustrates a relationship between a local network 110 protected by a firewall and an external server 120.

Referring to FIG. 1, local network devices 112, 114, and 116 constituting the local network 110 are connected to each other via a single network and also connected to an external network, such as the Internet. The local network 110 is also protected by a firewall or NAT. When the local network 110 is protected by a firewall or NAT, it is possible for the local network 110 to access the external server 120, whereas the external server 120 is blocked from accessing the local network 110.

For example, when the firewall is established using NAT, since the external server 120 does not know the private IP addresses of the local network 110, the external server 120 cannot control any of the local network devices 112, 114, and 116 in the local network 110.

As described above, according to the prior art, a method of remotely controlling local network devices, to which direct access from the outside is blocked, is not provided.

### SUMMARY OF THE INVENTION

The present invention provides a method of remotely controlling local network devices, to which direct access from the outside is blocked, and an apparatus for performing the method.

According to an aspect of the present invention, there is provided a method of remotely controlling local network devices, the method comprising: periodically receiving an access request from each local network device in a local network, to which direct access from the outside is blocked; if a connection between a local network device and a server located outside the local network is formed as a result of receiving the access request, determining whether a command to be transmitted to the local network device exists; and if it is determined that a command to be transmitted to the local network device exists, transmitting the command to the local network device while the connection is being formed to control the local network device.

Access to the local network device from the outside may be blocked by a firewall or Network Address Translation (NAT).

The command may be formed using an Extensible Markup Language (XML) format.

The command may be transmitted using a Simple Object Access Protocol (SOAP).

The command may be an operation that must be performed by the local network device according to a user's input or an operation to improve the performance of the local network device.

The period of the periodical receiving of the access request may be variably adjusted according to the performance of the local network device or the performance of the server.

The method may further comprise performing authentication to determine whether the user desiring to control the local network device is an authorized user, wherein if it is determined as the authentication result that the user is an authorized user, the user is allowed to control the local network device.

The method may further comprise registering the local network device in the server, wherein the registering of the local network device comprises: if it is determined as the authentication result that the user is an authorized user, receiving a unique code number for identifying the local network device from the local network device; determining whether registration of the received code number is allowed; and if it is determined that registration of the received code number is allowed, registering the received code number in the server.

The determining of whether registration of the received code number is allowed may comprise determining whether registration of the received code number is allowed according to whether the received code number satisfies a unique code number format of the local network device or whether the received code number has already been registered in the server.

The method may further comprise determining whether the local network device is available, wherein if it is determined that the local network device is available, the command is transmitted to the local network device, and if it is determined that the local network device is not available, the command is transmitted to the local network device after the local network device is available.

According to another aspect of the present invention, there is provided a server used for a method of remotely controlling local network devices, the server comprising: a receiver periodically receiving an access request from each local network device in a local network, to which direct access from the outside is blocked; a search unit determining whether a command to be transmitted to the local network device exists, if a connection between a local network device and a server located outside the local network is formed as a result of receiving the access request; and a transmitter that, if it is determined that a command to be transmitted to the local network device exists, transmits the command to the local network device while the connection is being formed to control the local network device.

Access to the local network device from the outside may be blocked by a firewall or Network Address Translation (NAT).

The command may be formed using an Extensible Markup Language (XML) format.

The command may be transmitted using a Simple Object Access Protocol (SOAP).

The command may be an operation that must be performed by the local network device according to a user's input, or an operation to improve the performance of the local network device.

The server may further comprise an authentication unit performing authentication to determine whether the user desiring to control the local network device is an authorized user, wherein if it is determined as the authentication result performed by the authentication unit that the user is an authorized user, the user is allowed to control the local network device.

The server may further comprise a device registration unit registering the local network device in the server, wherein the device registration unit comprises: a code number determiner, which if a unique code number for identifying the local network device is received from the local network device, determines whether registration of the received code number is allowed; and a code number registration unit registering the received code number in the server if it is determined that registration of the received code number is allowed, wherein the code number is received when it is determined as the authentication result performed by the authentication unit that the user is an authorized user.

The code number determiner may determine whether the registration of the received code number is allowed according to whether the received code number satisfies a unique code number format of the local network device or whether the received code number has already been registered in the server.

The server may further comprise a state determiner determining whether the local network device is available, wherein if it is determined that the local network device is available, the state determiner transmits the command to the local network device, and if it is determined that the local network device is not available, the state determiner transmits the command to the local network device after the local network device is available.

According to another aspect of the present invention, there is provided a local network device used for a method of remotely controlling local network devices, the local network device comprising: a transmitter periodically transmitting an access request to a server; a receiver receiving a command from the server if a connection between the local network device and the server is formed as a result of transmitting the access request using the transmitter; and an operation controller controlling an operation to be performed according to the command received by the receiver.

The local network device may further comprise a timer determining a period of the access request periodically transmitted by the transmitter, wherein the timer variably adjusts the period according to the performance of the local network device or the performance of the server.

According to another aspect of the present invention, there is provided a computer readable recording medium storing software instructions for execution by a computer for remotely controlling local network devices, the instructions comprising periodically receiving an access request from each local network device in a local network, to which direct access from the outside is blocked; if a connection between a local network device and a server located outside the local network is formed as a result of receiving the access request, determining whether a command to be transmitted to the local network device exists; and if it is determined that a command to be transmitted to the local network device exists, transmitting the command to the local network device while the connection is being formed to control the local network device.

### BRIEF DESCRIPTION OF THE DRAWINGS

The above and other aspects of the present invention will become more apparent by describing in detail exemplary embodiments thereof with reference to the attached drawings in which:

FIG. 1 illustrates a relationship between a local network protected by a firewall and an external server;

FIG. 2 is a block diagram of a server according to an exemplary embodiment of the present invention;

FIG. 3 is a flowchart illustrating an operational process of a Simple Object Access Protocol (SOAP);

FIG. 4 is a flowchart illustrating an operational process of a device registration unit according to an exemplary embodiment of the present invention;

FIG. 5 is a block diagram of a local network device according to an exemplary embodiment of the present invention;

FIG. 6 is a configuration for describing a method of remotely controlling local network devices according to an exemplary embodiment of the present invention; and

FIG. 7 is a flowchart illustrating a method of remotely controlling local network devices according to an exemplary embodiment of the present invention.

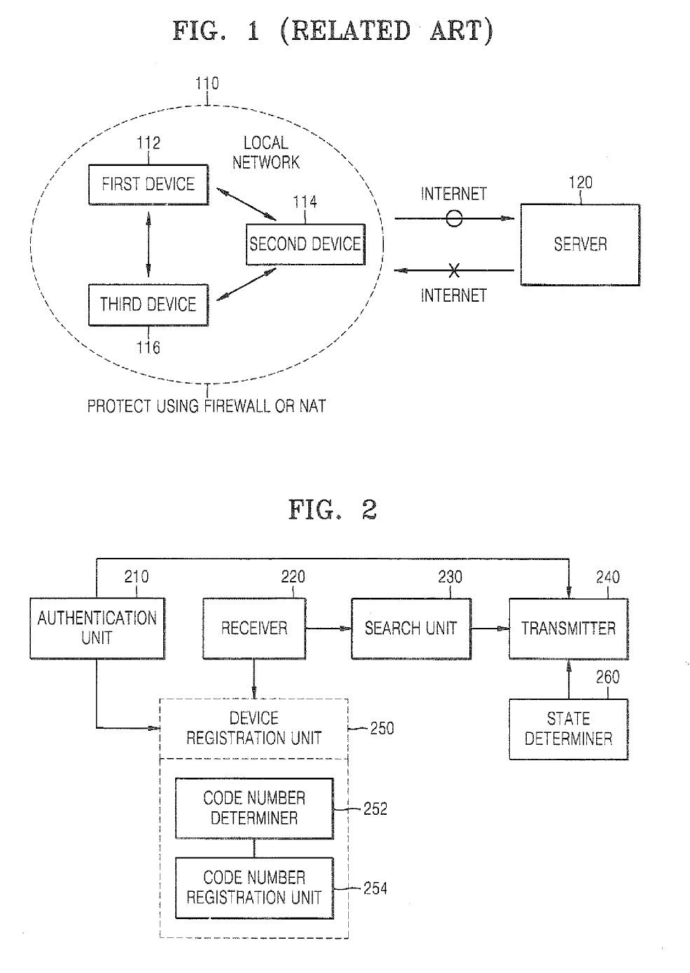

### DETAILED DESCRIPTION OF EXEMPLARY EMBODIMENTS OF THE INVENTION

Hereinafter, the present invention will be described in detail by explaining exemplary embodiments of the invention with reference to the attached drawings.

FIG. 2 is a block diagram of a server according to an exemplary embodiment of the present invention.

Referring to FIG. 2, the server includes an authentication unit 210, a receiver 220, a search unit 230, a transmitter 240, a device registration unit 250, and a state determiner 260.

The authentication unit 210 performs an authentication process to determine whether a user desiring to control a local network device is an authorized user.

The authentication process is necessary for registration and control of the local network device, which will be described later. That is, if the user is not an authorized user, the user cannot register the local network device in the server or control the local network device using the server.

The authentication unit 210 performs the authentication process by receiving a user Identification (ID) and a password from the user desiring to control the local network device and comparing the received user ID and password to user IDs and passwords of authorized users, which are stored in the server.

The authorized users are an owner of the local network device and individuals whom the owner of the local network device has allowed to use the local network device. Any one of the individuals whom the owner of the local network device has allowed to use the local network device is approved as an authorized user by acquiring a user ID and a password from the owner of the local network device and passing through the authentication process.

The receiver 220 periodically receives an access request from each local network device in a local network, to which direct access from the outside is blocked.

As described above, when a firewall is established using NAT, the local network device can access the outside (e.g., the server), while the server on the outside cannot access the local network device.

However, if a connection between the local network device and the server is formed due to the server periodically receiving the access request from the local network device, the server can access the local network device.

The access request of the local network device can be implemented in various manners. For example, if the local network device transmits a private IP address assigned thereto to the server as the access request, the server can directly access the local network device.

In more detail, in principle, since the private IP address is frequently changed, even if the server desires to access the local network device, the server cannot know a current private IP address, and thus the server cannot access the local network device. However, if the local network device directly transmits its private IP address to the server, the server can access the local network device using the received private IP address.

If a connection between the local network device and the server located outside the local network is formed due to the server periodically receiving the access request, the search unit 230 determines whether a command to be transmitted to the local network device exists.

The command may be an operation that must be performed by the local network device according to a user's input or an operation to improve the performance of the local network device. For example, if the local network device is a printer, the operation that must be performed by the local network device may be the printing of a document. In this case, if the user transmits a command to print the document to the printer in the local network using the server, the printer may receive the document from the server and print the received document.

The operation to improve the performance of the local network device may be the updating of a driver of the printer. In the case of updating the driver of the printer, although an updated driver may be directly transmitted to the local network device so as to execute it, a Uniform Resource Locator (URL) for downloading the driver may be transmitted to the local network device so that the local network device can directly access the URL, download the driver, and execute the driver.

The command may have an Extensible Markup Language (XML) format. XML is a general-use language for web development, and provides a homepage creation function and a search function, which are an improvement compared to the Hypertext Markup Language (HTML), and makes complex data processing of a client system easy. XML also allows an Internet user to easily edit and manage contents to be added to the web, and manipulate a structured database. However, the format of the command is not limited to XML.

If it is determined that a command to be transmitted to the local network device exists, the transmitter 240 transmits the control command to the local network device while the connection is being formed. As described above, in order for the transmitter 240 to transmit the command to control the local network device, the authentication process to determine whether the user is an authorized user must be successfully performed by the authentication unit 210.

The command may be transmitted using a Simple Object Access Protocol (SOAP).

SOAP is a standard for suggesting a method of efficiently realizing a call between various components existing in a network, and is based on the XML and Hypertext Transfer Protocol (HTTP) communication. SOAP provides a relatively simple, easy mechanism for communication between various systems and integration of the systems by using HTTP among various application layer protocols.

Since other application layer protocols use a unique Transmission Control Protocol (TCP) or User Datagram Protocol (UDP), many limitations occur due to a firewall installed in the Internet. However, SOAP provides a mechanism for efficiently performing remote communication with a plurality of unspecified clients or a specified server in the Internet without the limitations of a firewall associated with the HTTP.

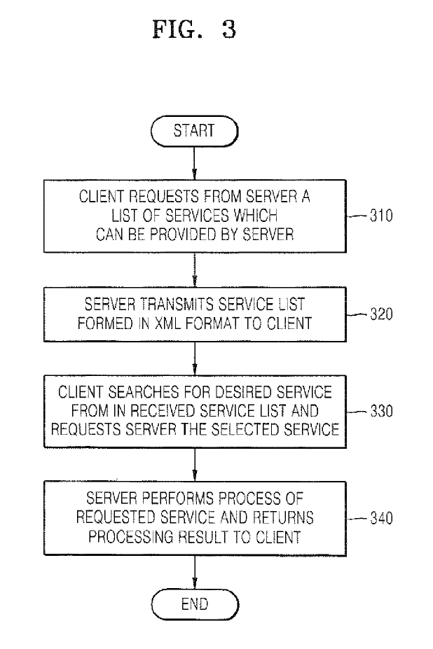

FIG. 3 is a flowchart illustrating an operational process of SOAP.

Referring to FIG. 3, in operation 310, a client requests a server for a list of services that the server can provide.

That is, the client requests from the server a service list formed in an XML format through HTTP, which is a protocol used to transmit a document between the server and the client over the Internet.

In operation 320, the server transmits the service list formed in the XML format to the client.

Here, operations 310 and 320 can be omitted if the client already knows the service list.

In operation 330, the client searches for a desired service in the received service list and requests from the server a selected service.

In operation 340, the server performs the requested service and returns the result to the client.

Referring back to FIG. 2, the device registration unit 250 registers the local network device in the server.

The device registration unit 250 includes a code number determiner 252 and a code number registration unit 254.

If a unique code number for identifying the local network device is received from the local network device, the code number determiner 252 determines whether registration of the received code number is allowed.

The receiver 220 receives the code number from the local network device only if it is determined based on the authentication result that the user is an authorized user. The local network device may be programmed so that the local network device transmits its code number to the server when it is turned on or when a specific key is clicked.

The code number determiner 252 determines whether the registration of the received code number is allowed according to whether the received code number satisfies a unique code number format of the local network device, or whether the received code number has already been registered in the server.

The code number may be a serial number of the local network device, which is provided by a manufacturer of the local network device. In this case, a method of determining whether the received code number satisfies the unique code number format is as follows.

If it is assumed that serial numbers provided by the manufacturer are M2000 to M5000, only a serial number obtained by combining M at the beginning and any one of numbers 2000 to 5000 can satisfy the code number format. If a received serial number does not lie within a range or does not have a format of the provided serial numbers, i.e., if M5100 or K2300 is received, the received serial number cannot satisfy the code number format.

The determination of whether the received code number has already been registered in the server is performed to prevent the same code number from being registered in the server when the code number of the local network device has already been registered in the server. For example, if M2000 has already been registered in the server, the code number M2000 cannot be registered in the server again.

The code number registration unit 254 registers the received code number in the server if it is determined as the determination result of the code number determiner 252 that registration of the received code number is allowed.

The reason why code numbers are registered in the server is so that in the future, a local network device can be selected from a list and used after the list of available local network devices is created by registering the code numbers.

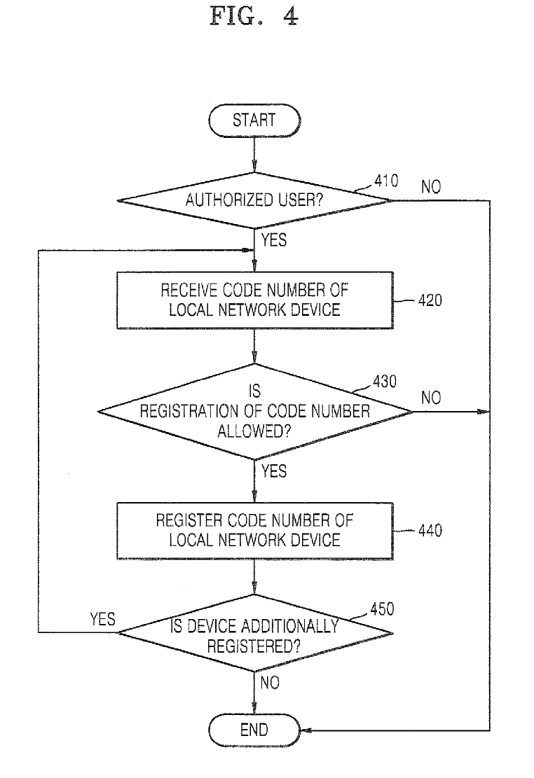

FIG. 4 is a flowchart illustrating an operational process of the device registration unit 250 according to an exemplary embodiment of the present invention.

Referring to FIG. 4, it is determined in operation 410 whether a user desiring to register a local network device is an authorized user.

That is, it is determined using the authentication unit 210 whether a user ID and a password of the user desiring to register the local network device is the same as a user ID and password of an authorized user registered in a server.

If it is determined in operation 410 that the user desiring to register the local network device is an authorized user, a code number of the local network device is received in operation 420.

It is determined in operation 430 whether registration of the received code number is allowed.

As described above, the code number determiner 252 determines whether registration of the received code number is allowed according to whether the received code number satisfies a unique code number format of the local network device and whether the received code number has already been registered in the server.

If it is determined in operation 430 that registration of the received code number is allowed, the received code number of the local network device is registered in operation 440.

It is determined in operation 450 whether a local network device to be additionally registered exists. If it is determined in operation 450 that a local network device to be additionally registered exists, the process returns to operation 420, and if it is determined in operation 450 that no local network device to be additionally registered exists, the process ends.

Referring back to FIG. 2, if it is determined that the local network device is available, the state determiner 260 transmits the command to the local network device, and if it is determined that the local network device is not available, the state determiner 260 transmits the command to the local network device after the local network device is available.

The local network device may not be available when the local network device is turned off or cannot operate due to malfunction.

If a command is effective only if it is immediately executed, the command is not transmitted even after the local network device becomes available from an unavailable state.

For example, if local network devices to be used are a TV and a Digital Versatile Disc-Recordable (DVD-R) player, it is assumed that a TV program of a specified date and a specified time intends to be recorded. In this case, when a command cannot be transmitted because the TV or DVD-R player is not available, even if the TV or DVD-R player is available in the future, since the TV program has already been broadcasted, the command for recording the TV program is not transmitted any more. As described in the example, a server according to an exemplary embodiment of the present invention can simultaneously control more than two local network devices.

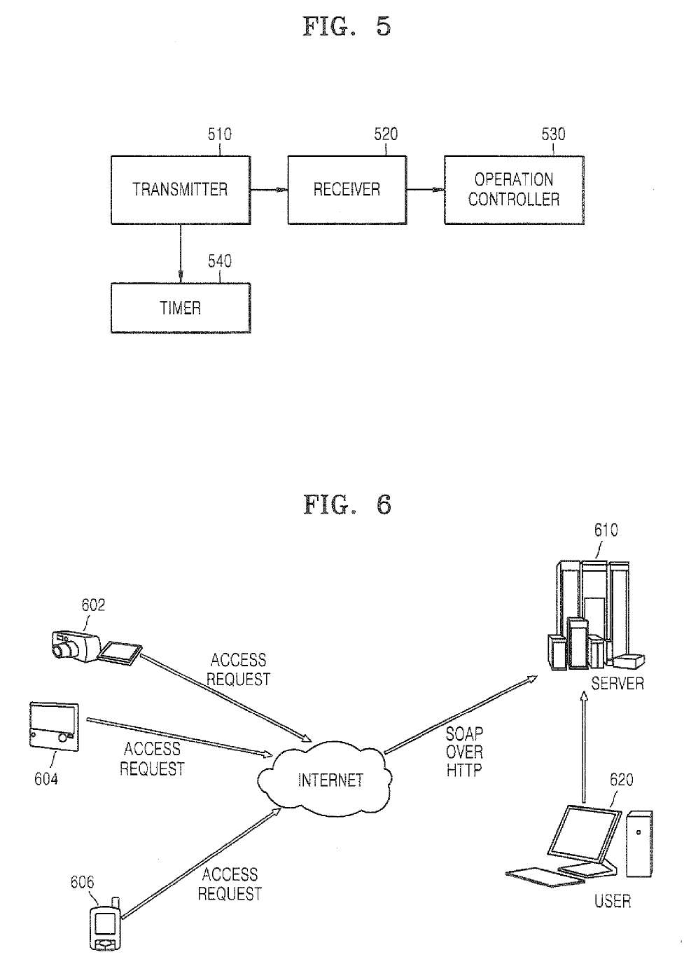

FIG. 5 is a block diagram of a local network device according to an exemplary embodiment of the present invention.

Referring to FIG. 5, the local network device includes a transmitter 510, a receiver 520, an operation controller 530, and a timer 540.

The transmitter 510 periodically transmits an access request to a server.

The timer 540 determines a period of the access request periodically transmitted by the transmitter 510. The timer 540 may variably adjust the period of the access request according to the performance of the local network device or the performance of the server. For example, when the access request is performed once every 10 seconds, if overload of the local network device or the server occurs, the access request is performed once every 20 seconds. In this way, the transmission period of the access request can be adjusted.

If a connection between the local network device and the server is formed as a result of transmitting the access request using the transmitter 510, the receiver 520 receives a command from the server.

The operation controller 530 controls an operation to be performed according to the command received by the receiver 520.

FIG. 6 is a configuration for describing a method of remotely controlling local network devices according to an exemplary embodiment of the present invention.

Referring to FIG. 6, the local network devices are a digital camera 602, a Portable Multimedia Player (PMP) 604, and a cellular phone 606. The local network devices 602, 604, and 606 are connected to a server 610 in a remote area via the Internet. In addition, a terminal 620 of a user is connected to the server 610 so that an authorized user can access the server 610.

Each of the local network devices 602, 604, and 606 transmits an access request to the server 610. A user desiring to control the local network devices 602, 604, and 606 transmits a command to the local network devices 602, 604, and 606 by accessing the server 610 using the terminal 620. If a connection between the local network devices 602, 604, and 606 and the server 610 is formed in response to the access request received from each of the local network devices 602, 604, and 606, the server 610 transmits the user's command to each of the local network devices 602, 604, and 606.

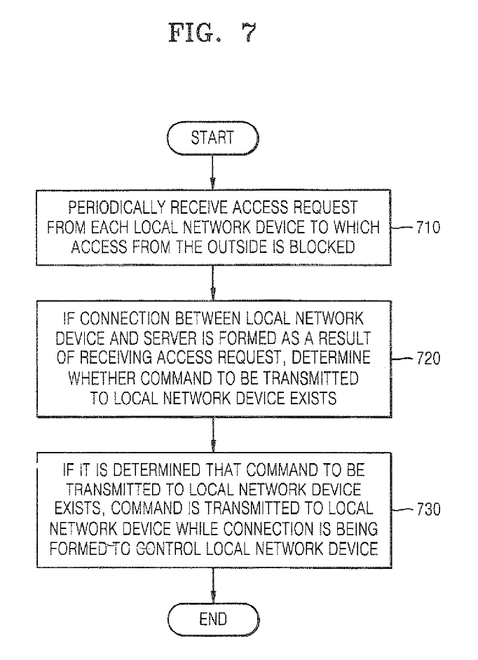

FIG. 7 is a flowchart illustrating a method of remotely controlling local network devices according to an exemplary embodiment of the present invention.

Referring to FIG. 7, in operation 710, an access request is periodically received from each local network device, to which direct access from the outside is blocked.

In operation 720, if a connection between a local network device and a server is as a result of receiving the access request, it is determined whether a command to be transmitted to the local network device exists.

In operation 730, if it is determined that a command to be transmitted to the local network device exists, the command is transmitted to the local network device while the connection is being formed to control the local network device.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet).

As described above, according to the present invention, local network devices, to which direct access from the outside is blocked, can be remotely controlled.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of remotely controlling one or more local network devices, the method comprising:
periodically receiving an access request from each of the one or more local network devices in a local network, to which direct access from outside the local network is blocked;
if a connection between a first local network device of the one or more local network devices and a server located outside the local network is formed as a result of receiving the access request, determining whether a command to be transmitted to the first local network device exists; and
if it is determined that the command to be transmitted to the first local network device exists, transmitting the command to the first local network device while a connection is being formed, in order to control the first local network device.

2. The method of claim 1, wherein a firewall or Network Address Translation (NAT) is used to block access to the local network from outside the local network.

3. The method of claim 1, wherein the command is formed using an Extensible Markup Language (XML) format.

4. The method of claim 1, wherein the command is transmitted using a Simple Object Access Protocol (SOAP).

5. The method of claim 1, wherein the command is an operation that must be performed by the first local network device according to a user's input or an operation to improve the performance of the first local network device.

6. The method of claim 1, wherein a period of the periodical receiving of the access request is variably adjusted according to a performance of the first local network device or a performance of the server.

7. The method of claim 1, further comprising performing authentication to determine whether a user desiring to control the first local network device has authorization,
wherein if it is determined based on an authentication result that the user has authorization, the user is allowed to control the first local network device.

8. The method of claim 7, further comprising registering the first local network device in the server,
wherein the registering of the first local network device comprises:
if it is determined based on the authentication result that the user has authorization, receiving a unique code number for identifying the first local network device from the first local network device;
determining whether registration of the received code number is allowed; and
if it is determined that registration of the received code number is allowed, registering the received code number in the server.

9. The method of claim 8, wherein the determining of whether registration of the received code number is allowed comprises determining whether registration of the received code number is allowed based on whether the received code number satisfies a unique code number format of the first local network device or whether the received code number has already been registered in the server.

10. The method of claim 1, further comprising determining whether the first local network device is available,
wherein if it is determined that the first local network device is available, the command is transmitted to the first local network device, and
if it is determined that the first local network device is not available, the command is transmitted to the first local network device after the first local network device is available.

11. A server used for remotely controlling one or more local network devices, the server comprising:
a receiver which periodically receives an access request from each of the one or more local network devices in a local network, to which direct access from the outside is blocked;
a search unit which determines whether a command to be transmitted to a first local network device exists, if a connection between the first local network device and a server located outside the local network is formed as a result of receiving the access request; and
a transmitter that, if it is determined that the command to be transmitted to the first local network device exists, transmits the command to the first local network device while the connection is being formed, in order to control the first local network device.

12. The server of claim 11, wherein access to the first local network device from the outside is blocked by a firewall or Network Address Translation (NAT).

13. The server of claim 11, wherein the command is formed using an Extensible Markup Language (XML) format.

14. The server of claim 11, wherein the command is transmitted using a Simple Object Access Protocol (SOAP).

15. The server of claim 11, wherein the command is an operation that must be performed by the first local network device according to a user's input or an operation to improve the performance of the first local network device.

16. The server of claim 11, further comprising an authentication unit which performs authentication to determine whether a user desiring to control the first local network device has authorization,
wherein if it is determined based on an authentication result that the user has authorization, the user is allowed to control the first local network device.

17. The server of claim 16, further comprising a device registration unit registering the first local network device in the server,
wherein the device registration unit comprises:
a code number determiner, which if a unique code number for identifying the first local network device is received from the first local network device, determines whether registration of the received unique code number is allowed; and
a code number registration unit which registers the received code number in the server if it is determined that registration of the received code number is allowed,
wherein the code number is received when it is determined based on the authentication result that the user has authorization.

18. The server of claim 17, wherein the code number determiner determines whether the registration of the received code number is allowed based on whether the received code number satisfies a unique code number format of the first local network device or whether the received code number has already been registered in the server.

19. The server of claim 11, further comprising a state determiner which determines whether the first local network device is available,
wherein if it is determined that the first local network device is available, the state determiner transmits the command to the first local network device, and if it is determined that the first local network device is not available, the state determiner transmits the command to the first local network device after the first local network device is available.

20. A local network device used for a method of remotely controlling one or more local network devices, the local network device comprising:
a transmitter which periodically transmits an access request to a server;
a receiver which receives a command from the server if a connection between the local network device and the server is formed as a result of transmitting the access request using the transmitter; and
an operation controller which controls an operation to be performed based on the command.

21. The local network device of claim 20, further comprising a timer which determines a period of the access request periodically transmitted by the transmitter,
wherein the timer variably adjusts the period according to a performance of the local network device or a performance of the server.

22. A computer readable recording medium storing software instructions for enabling a computer to perform operations for remotely controlling local network devices, the operations comprising:
periodically receiving an access request from each of a plurality of local network devices in a local network, to which direct access form outside the local network is blocked;
if a connection between a local network device and a server located outside the local network is formed as a result of receiving the access request, determining whether a command to be transmitted to the local network device exists; and
if it is determined that the command to be transmitted to the local network device exists, transmitting the command to the local network device while a connection is being formed, in order to control the local network device.
